(19) United States
(12) Patent Application Publication
(10) Pub. No.: US 2014/0172593 A1
(43) Pub. Date: Jun. 19, 2014

(54) LATE CONTENT QUALIFICATION

(71) Applicants: Thomas J Gilg, Corvallis, OR (US); Larry Mull, Corvallis, OR (US); Jun Gu, Corvallis, OR (US); Tammy Fuchigami, Corvallis, OR (US)

(72) Inventors: Thomas J Gilg, Corvallis, OR (US); Larry Mull, Corvallis, OR (US); Jun Gu, Corvallis, OR (US); Tammy Fuchigami, Corvallis, OR (US)

(21) Appl. No.: 14/235,261

(22) PCT Filed: Jul. 29, 2011
(86) PCT No.: PCT/US2011/045989

§ 371 Date: Jan. 27, 2014

(51) Int. Cl. G06Q 30/02; G06Q 30/06

(52) U.S. Cl. CPC G06Q 30/0277; G06Q 30/0603
USPC 705/14.73

(57) ABSTRACT

A method includes for late content qualification includes obtaining metadata and content for each of a plurality of publications. The availability of the plurality of products for production is advertised without first confirming that content for any of the plurality of publications can be qualified. An attempt is made to qualify content for an ordered one of the publications having been advertised. The order is fulfilled with qualified content only if the attempt is successful.

### BACKGROUND

Digital publisher's produce printed and electronic books, magazines and other viewable material on demand. Such products can be referred to as publications. Publications, in this context, are products that when produced convey information to a viewer. A publication can take the physical form of a printed product or the form of an electronic product such as an eBook. The raw materials of a publication include digital content that can be processed to generate the publication and metadata associated with the publication. Such metadata can be used to identify the publication's title, author, price and any other associated information that may be used to advertize the publication.

### DRAWINGS

FIG. 1 depicts an environment in which various embodiments may be implemented.

FIG. 2 depicts a system according to an example.

FIG. 3 is a block diagram depicting a memory and a processor according to an example.

FIG. 4 is a block diagram depicting an implementation of the system of FIG. 2.

FIG. 5 is a flow diagram depicting steps taken to implement an example.

FIG. 6 is a communication sequence diagram according to an example.

### DETAILED DESCRIPTION

INTRODUCTION: As industry shifts from analog to digital publishing, the raw materials for collections of publications are obtained and made available for on demand fulfillment of those publications. Prior to delivering the content of a publication for production, the content needs to be first qualified to ensure that it can be used to produce a requested publication, when produced, the publication meets or exceeds some predetermined standard. The qualification of content for larger collections can take significant amounts of time and can prove to be a major expense in enabling the fulfillment of on demand publication orders.

Various embodiments described below were developed in an effort to enable collections of publications to be advertised or otherwise offered for on-demand production without first confirming that the content for any product can be qualified. In a particular example, metadata and content for each of a plurality of publications are obtained. The plurality of publications are advertised as being available for production without first confirming that content for any of the plurality of publications can be qualified. Once a given one of the advertised publications is ordered, an attempt is made to qualify the content for that publication. The order is fulfilled with qualified content only if the attempt is successful.

The following description is broken into sections. The first, labeled “Environment,” describes an exemplary environment in which various embodiments may be implemented. The second section, labeled “Components,” describes examples of various physical and logical components for implementing various embodiments. The third section, labeled as “Operation,” describes steps taken to implement various embodiments.

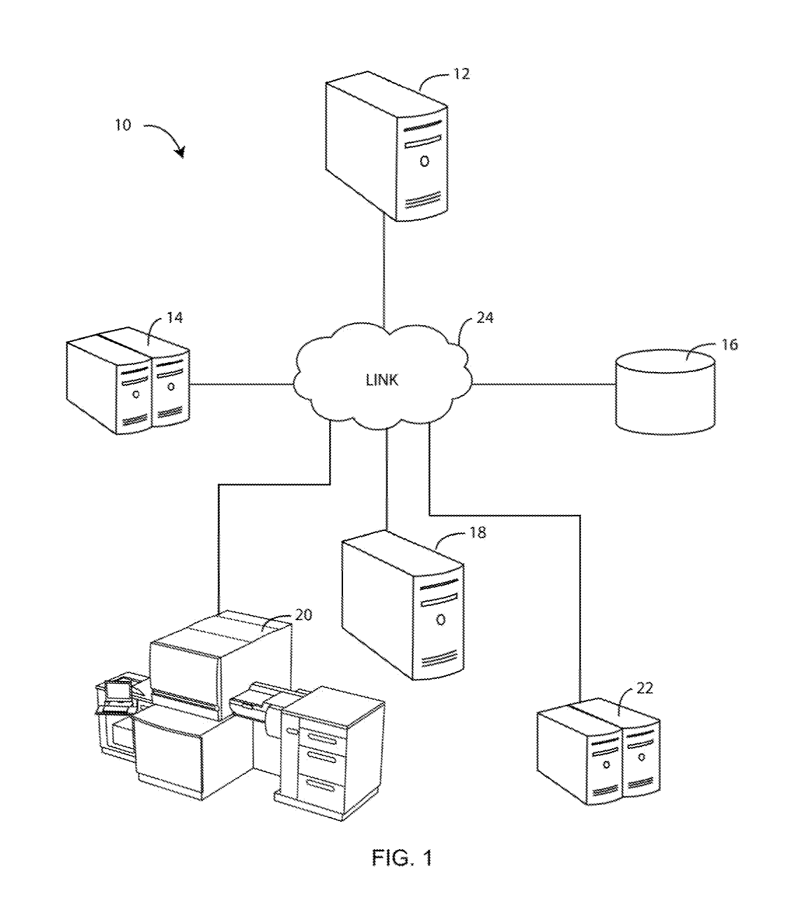

ENVIRONMENT: FIG. 1 depicts an environment 10 in which various embodiments may be implemented. Environment 10 is shown to include content owner 12, fulfillment device 14, data store 16, order device 18, and production services 20 and 22. Content owner device represents any computing device from which the raw materials of a collection of publications may be obtained. The raw materials of a publication, for example, can include metadata for use in merchandizing the product as well as the content for use in producing the product. Content owner 12 may be a computer via which a person such as a traditional analog publisher who desires to make a content collection available for use in the on demand production of publications.

Fulfillment device 14 represents generally any computing device configured to obtain the raw materials from content owner 12 and utilizing those materials to fulfill orders for the publications. Data store 16 represents generally any memory device that can be used to store the raw materials obtained from content owner 12.

Order device 18 represents generally any computing device that can be used to place orders for publications from fulfillment device 14. Production service 20 represents resources configured to produce printed publications such as books, magazines, and the like. Production service 22 represents resources configured to produce electronic publications such as eBooks.

Link 24 represents generally one or more of a cable, wireless, fiber optic, or remote connections via a telecommunication link, an infrared link a radio frequency link, or any other connectors or systems that provide electronic communication. Link 24 may include, at least in part, an intranet, the Internet, or a combination of both Link 24 may also include intermediate proxies, routers, switches, load balancers, and the like.

In the example of FIG. 1, content owner 12, fulfillment device 14, data store 16, order device 18, and services 20 and 22 are depicted as distinct devices. However, each may represent multiple devices. For example, fulfillment device 22 may represent multiple devices interconnected via link 24 to perform the specified functions. The same can be said for data store 16 and content owner 12.

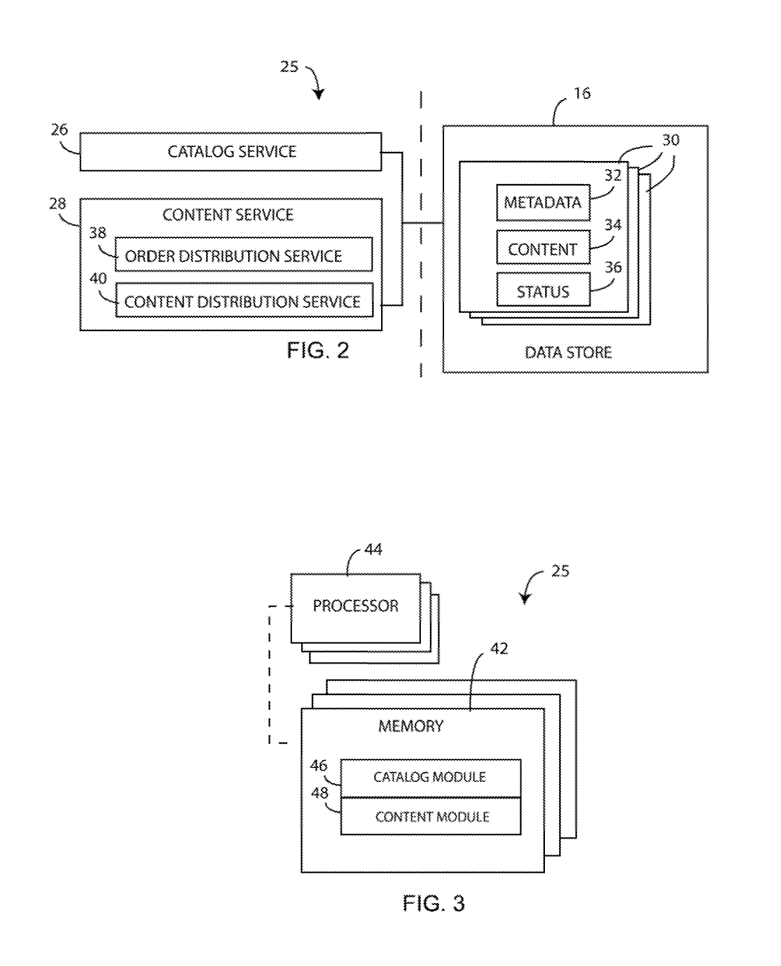

COMPONENTS: FIGS. 2-4 depict examples of physical and logical components for implementing various embodiments. FIG. 2 depicts system 25 for fulfilling orders for publications in which the content for producing each publication is qualified after the product has been advertised and ordered. In this fashion, the expense involved with qualifying content need not be incurred until demand for the product is established by the order.

In the example of FIG. 2, system 25 includes catalog service 26 and content service 28. System 25 is shown to be in communication with data store 16 which in turn is shown to include publication materials 30. Catalog service represents generally any combination of hardware and programming configured to obtain metadata for each of a plurality of publications. Referring to FIG. 1, this metadata may be obtained from content owner 12. Metadata for a given publication, in this context, is electronic data that can be used in merchandizing that publication. The electronic data, for example, may identify information such as a title, an author, a retail price, and even an ISBN (International Standard Book Number) for the publication.

Catalog service 26 is also responsible for advertising the availability of the plurality of publications for production without first confirming that content for any of the plurality of publications can be qualified for production. Advertising, in this context, can include communicating electronic data representing a catalog that lists the plurality of publications as being available for production. With respect to FIG. 1, that data may be communicated to order device 18 so that order device 18 can use the data to present the listing of publications to consumers for ordering.

Content service 28 represents generally any combination of hardware and programming configured to obtain content for the plurality of publications, attempt to qualify content for an ordered one of the publications having been advertised by the catalog service, and to fulfill the order with qualified content only if the attempt is successful. Again referring to FIG. 1, the content may be obtained from content owner 12. The content may be in any of a number of electronic forms including but not limited to PDF. Attempting to quality the content for an ordered publication can include ingesting the content and determining if the ingested content can be used to produce the ordered publication at or above a predetermined standard.

Ingesting can include characterizing the content and, if indicated by the characterization, converting the content to a format from which it can be used to produce the publication. It is initially noted that the characterization may indicate that a conversion would not be successful or that the content is suitable as is and need not be converted to be used for producing the publication. When characterizing the content, the details of the content are examined. For example content is examined to determine whether the content file or files appear to be intact. An intact PDF file should end in “%%EOF”. The content is also examined to identify color and page characteristics. With respect to color, content may be mono or may have color. With respect to page characteristics, content can be examined to extract a page count, page dimensions, and page orientations. The content can be examined to determine if page sizes and orientations are consistent. The content can be examined to determine if the pages contain images, text, or both, and, if both, which if either is predominant.

As noted, content service 28 is responsible for making a determination as to whether ingested content can be used to produce the ordered publication at or above a predetermined standard. In doing so, content service 28 may evaluate the information gleaned from characterizing the content and the results of converting the content. It is noted, however, that ingesting the content may not result in the content being converted. Such may be because content service 28 determines that, based on the characterization, the content is ready for use to produce the publication as is. Alternatively, content service 28 may determine based on the characterization that the content is simply not suitable for converting.

Take a collection of novels for example. It may be desirable to offer multiple publications for each novel:
a 4″×7″ paperback version
a 6.9″×7.8″ hardcover version; and
an e-Reader download version.
   For a given novel, each of the three publications may share the same content—a common PDF file. Qualifying the content for each publication for that novel may return different results. Characteristics of the content may reveal that it is only suited for use in producing one publication type but not another. For example, the content may be deemed suitable for use in producing the hardcopy publication noted above. This may be because the page characteristics of the content closely match the page characteristics of the publication. The same content may not be deemed suitable for use in producing the paperback publication. This may be because the page characteristics of the content indicate that a conversion will result in a publication that does not meet a predefined standard. For example, the content may be primarily images so that converting the page size of the content, results undesirable page breaks interrupting the flow of the content. Where the publication is an eBook, the characterization of the content may reveal that the content cannot be converted to, for example, to the ePub or other required eReader format.

Before catalog service 26 advertises publications as being available for production, content service 28, in an example, is responsible for performing a sanity check on the content for each publication. In this example, catalog service 26 advertises a publication if the content for that publication passes the sanity check. A sanity check is an examination of the content to determine a likelihood that that the content can be used to produce a given publication and is less comprehensive and computationally intensive than qualifying the content as discussed above. In performing a sanity check on PDF content for an eReader publication, for example, the PDF content may be examined to determine if it contains true vectors, fonts and pictures. If so, then there is a reasonable likelihood that the content can be used to produce the eReader publication. If instead, the PDF is all page scans, resealing the content is much more difficult and the content is not suitable for an eReader publication due to the likely size and aspect-ratio mismatches. In the latter case, content service 28 reports to catalog service failure of the sanity check, and catalog service refrains from advertising that given publication.

Data store 16 is shown to include a collection of publication materials 30. In this example, these are depicted as records 30 each corresponding to a particular publication. Each record 30 is associated with a given publication and includes metadata 32, content 34, and status 36. As catalog service 26 obtains metadata it populates records 30. Likewise, as content service 28 obtains content it populates records 30 with that content. After performing a sanity check on the content of a record 30, content service 28, the results are made available as status 36 in that record 30. Thus, prior to advertising the publication associated with record 30, catalog service 26 reviews status 36 to confirm that the content for the publication has passed the sanity check.

After attempting to qualify content 34 for a given record 30, content service 28 updates status 36 for that record 30 to indicate either the content passed or failed the qualification. If status 36 indicated that the content 34 failed qualification, catalog service 26, in an example, is responsible for no longer advertising the associated publication as available for production. As described above, a failed qualification is an indication that the corresponding content 34 cannot be used to produce the publication at or above a predetermined standard. Where catalog service 26 generates a catalog of publications, it removes the publication associated with status 36 reflective of a qualification failure.

In the example of FIG. 2, content service 2 is shown to include order distribution service 38 and content distribution service 40. Order distribution service 38 is responsible for receiving an order for the one of the plurality of publications and, in response, communicating a request to ingest the content for the ordered publication to content distribution service 40. Referring to FIG. 1, that order may be receive from order device 18. Content distribution service 40 is responsible for attempting to qualify the content for the ordered publication by ingesting the content and determining if the ingested content can be used to produce the ordered publication at or above a predetermined standard. Content distribution service 40 may ingest the content for an ordered publication by characterizing the content and, if indicated by the characterization, converting the content to a format from which it can be used to produce the publication. To indicate that the content has passed or failed qualification, status 36 may be updated in record 30 for the corresponding publication.

If content distribution service 40 determines that the content fails qualification, order distribution service 30 is responsible for rejecting the order of the given publication. Upon a determination that the content has passed qualification and can be used to produce the publication at or above the predetermined standard, order distribution service 40 is responsible for communicating a production instruction for the content. Content distribution service 38 is responsible for communicating the ingested content for use in producing the ordered publication according to the production instruction. Referring to FIG. 1, this instruction may be communicated to production service 20 or 22. That instruction then may be used to by the given production service 20 or 22 to retrieve the ingested content from content distribution service 40. Alternatively, content distribution service 40 may communicate the ingested content without first receiving a request. The production instruction, as alluded to, may include information for retrieving the ingested content. It may also include an instruction guiding or dictating how the content is to be used to product the publication.

Upon receiving an order for a publication, content distribution service 38 may examine status 36 of record 30 associated with the publication. Where status 36 indicates that content 34 for record 30 has already passed qualification, order distribution service 38 may communicate the production instruction without first requesting that the content distribution service 40 ingest the content for the ordered publication. Where content for a given publication has passed qualification, content distribution service 40 can then communicate the previously ingested content so that it may be used to produce the publication.

In foregoing discussion, various components were described as combinations of hardware and programming. Such components may be implemented in a number of fashions. Looking at FIG. 3, the programming may be processor executable instructions stored on tangible memory media 42 and the hardware may include a processor or processors 44 for executing those instructions. Memory 42 can be said to store program instructions that when executed by processor 44 implement system 25 of FIG. 2. Memory 42 may be integrated in the same device as processor 44 or it may be separate but accessible to that device and processor 44.

In one example, the program instructions can be part of an installation package that when installed can be executed by processor 44 to implement system 25. In this case, memory 42 may be a portable medium such as a CD, DVD, or flash drive or a memory maintained by a server from which the installation package can be downloaded and installed. In another example, the program instructions may be part of an application or applications already installed. Here, memory 42 can include integrated memory such as a hard drive.

In FIG. 3, the executable program instructions stored in memory 42 are depicted as catalog module 46, content module 48. Catalog module 46 represents program instructions that when executed cause the implementation of catalog service 26 of FIG. 2. Likewise, content nodule 48 represent program instructions that when executed cause the implementation of content service 28.

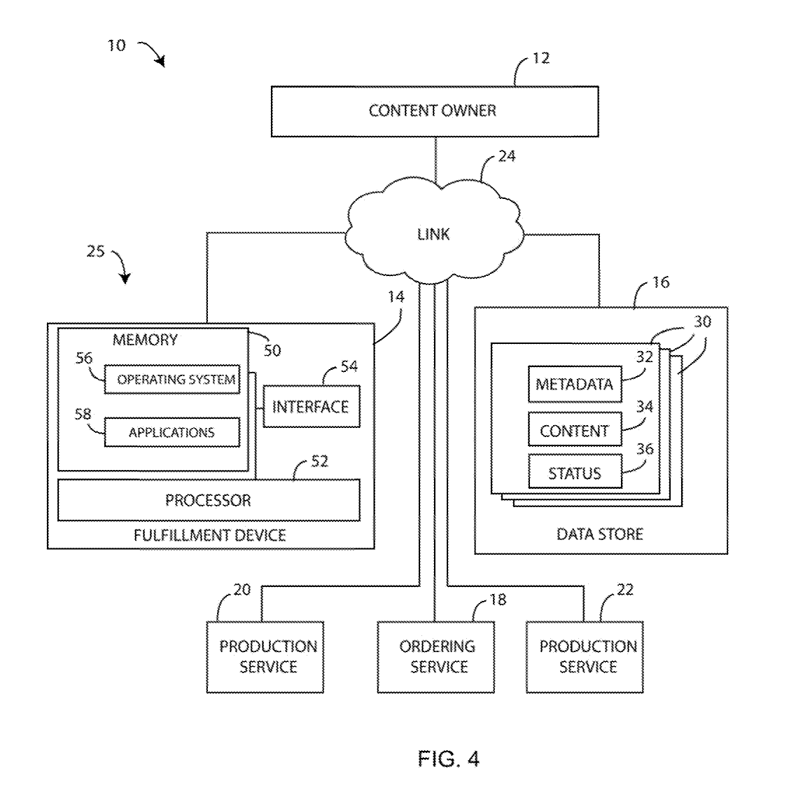

As a further example, FIG. 4 depicts a block diagram of system 25 implemented by fulfillment device 14. In the example of FIG. 4, fulfillment device 14 is shown to include memory 50, processor 52, and interface 54. Processor 52 represents generally any processor configured to execute program instructions stored in memory 50 to perform various specified functions. Interface 54 represents generally any interface enabling fulfillment device 14 to communicate via link 24 with content owner 12, order device 18, and production services 20 and 22.

Memory 50 is shown to include operating, system 56 and applications 58. Operating system 56 represents a collection of programs that when executed by processor 52 serve as a platform on which applications 58 can run. Examples of operating systems include, but are not limited, to various versions of Microsoft's Windows® and Linux®. Applications 58 represent program instructions that when execute by processor 52 implement system 25 of FIG. 2.

Looking at FIG. 2, catalog and content services 26 and 28 are described a combinations of hardware and programming. The hardware portions may, depending on the embodiment, be implemented as processor 52. The programming portions, depending on the embodiment, can be implemented by operating system 56, applications 58, or combinations thereof. It is also noted that while fulfillment device 14 is shown as a single device, it can be implemented such that the depicted components 50-58 are replicated, if appropriate, and distributed across multiple devices.

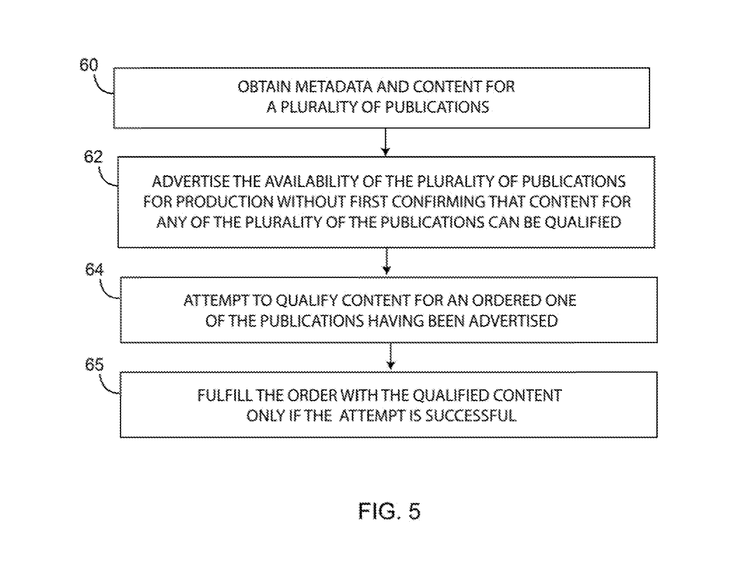

OPERATION: FIG. 5 is a flow diagram of steps taken to implement a method for late content qualification. In discussing FIG. 5, reference is made to the diagrams of FIGS. 1-4 to provide contextual examples. Implementation, however, is not limited to those examples. Metadata and content are obtained for each of a plurality of publications (step 60). In the example of FIG. 2, catalog service 26 may be responsible for obtaining the metadata and content service 28 may be responsible for obtaining the content. The metadata and content may be obtained from content owner 12 of FIG. 1. Once obtained, the metadata and content can be used to create records 30 in data store 16.

The availability of the plurality of products for production is advertised without first confirming that content for any of the plurality of publications can be successfully qualified (step 62). Referring to FIG. 2, catalog service 26 may be responsible for implementing step 62. Advertising, for example, may include communicating or otherwise making available electronic data indicative of a catalog or listing of the publications to order device 18 of FIG. 1.

An attempt is made to qualify the content for an ordered one of the publications having been advertised (step 64). That order is fulfilled with qualified content only if the attempt is successful (step 65). Step 64, for example, can include receiving the order, ingesting the content for the ordered publication, and determining if the ingested content can be used to produce the ordered publication at or above a predetermined standard. Ingesting can include characterizing the content and, if indicated by the characterization, converting the content to a format from which it can be used to produce the publication. Referring to FIG. 2, steps 64 and 65 may be performed by content service 28.

Step 65 can include upon a determination that the content can be used to produce the publication at or above the predetermined standard, communicating a production instruction for the content and communicating the ingested content for use in producing the ordered publication according to the production instruction. Upon a determination that the content cannot be used to produce the ordered publication at or above the predetermined standard, a rejection of the order may be communicated and the particular one of the publications ceased to be advertised.

Upon a determination that the content can be used to produce the ordered publication at or above the predetermined standard, the content may be identified as qualified. Referring to FIG. 2, such may be accomplished by content service 28 updating status 26 of record 30 for the publication. Thus, in response to a subsequent order for the same publication, a subsequent production instruction can be communicated for the publication without first requesting that the content be ingested or otherwise qualified. As the content has been previously ingested and determined capable of use to produce the ordered publication at or above a predetermined standard, that content can be communicated for use in producing the publication without requalification.

FIG. 7 is a communication sequence diagram of actions taken with respect to system 25 of FIG. 2 in environment 10 of FIG. 1. Initially content owner avails metadata to catalog service 28 (step 66a) and content to content distribution service 40 (step 66b). The content and the metadata are for a collection of publications. Content distribution service performs a sanity check on the content for each publication (step 68), and communicates the results to catalog service 26 (step 70). For the publications whose content passed the sanity check, catalog service 26 advertises to order service 18 those publications as available for production without first confirming that the content for any publication can be qualified for use in producing that publication (step 72).

Order distribution service 38 receives an order for a specified one of the collection of publications from order service 18 (step 74) and communicates an ingestion request to content distribution service 40 (step 76). Content distribution service 40 ingests the content for the ordered publication and determines if that content can be used to produce the ordered publication at or above a predetermined standard (step 78). Content distribution service 40 communicates the results to catalog service 26 (step 80), so that catalog service 26 can update the status of the publication and cease to advertise the publication if the content failed qualification (step 82).

Catalog service 26 informs order distribution service 38 as to whether or not the order for the publication can be fulfilled (step 84). If the order cannot be fulfilled, order distribution service 38 communicates a rejection to order device 18 (step 86a). If the order can be fulfilled, order distribution service 38 communicates a production instruction to production service 20 or 22 (step 86b). Content distribution service 40 then communicates the content ingested for the ordered publication to production service 20 or 22 (step 88).

CONCLUSION: FIGS. 1-4 aid in depicting the architecture, functionality, and operation of various embodiments. In particular, FIGS. 1-4 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

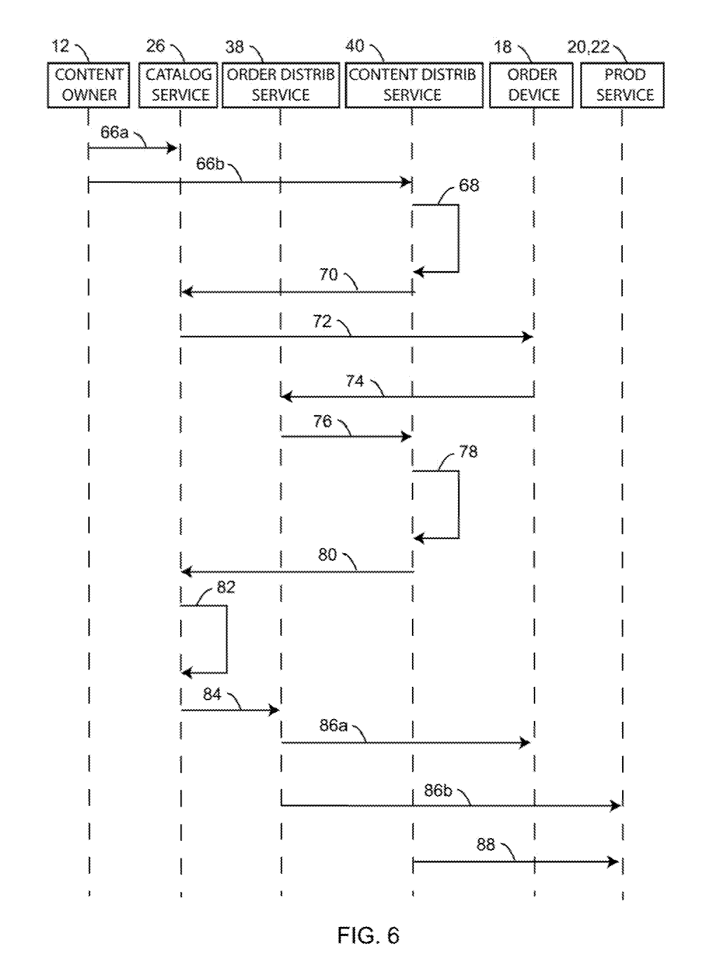

Although the flow diagram of FIG. 5 and the communication sequence diagram of FIG. 6 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for late content qualification, comprising:
obtaining metadata and content for each of a plurality of publications:
advertising the availability of the plurality of products for production without first confirming that content for any of the plurality of publications can be qualified;
attempting to qualify content for an ordered one of the publications having been advertised; and
fulfilling the order with qualified content only if the attempt is successful.

2. The method of claim 1, comprising performing a sanity check on the content for each of the plurality of publications and wherein advertising comprises advertising only those of the plurality of publications whose content passes the sanity check.

3. The method of claim 1, comprising receiving the order for the one of the plurality of publications, and wherein attempting to qualify content comprises, in response to the order, ingesting the content for the ordered publication and determining if the ingested content can be used to produce the ordered publication at or above a predetermined standard.

4. The method of claim 3, wherein ingesting comprises characterizing the content and, if indicated by the characterization, converting the content to a format from which it can be used to produce the publication.

5. The method of claim 3, wherein fulfilling comprises:
upon a determination that the content can be used to produce the publication at or above the predetermined standard, communicating a production instruction for the content and communicating the ingested content for use in producing the ordered publication according to the production instruction; and
upon a determination that the content cannot be used to produce the ordered publication at or above the predetermined standard, communicating a rejection of the order for the one of the plurality of publications.

6. A system comprising a catalog service and a content service, wherein:
the catalog service is configured to obtain metadata for each of a plurality of publications and to advertise the availability of the plurality of publications for production without first confirming that content for any of the plurality of publications can be qualified: and
the content service is configured to obtain, content for the plurality of publications, attempt to qualify content for an ordered one of the publications having been advertised by the catalog service, and to fulfill the order with qualified content only if the attempt is successful.

7. The system of claim 6, wherein the content service includes an order distribution service and a content distribution service, wherein:
the order distribution is configured to receive an order for the one of the plurality of publications and, in response, communicate a request to ingest the content for the ordered publication to the content distribution service; and
the content distribution service is configured to qualify the content for the ordered publication by ingesting, the content and determining if the ingested content can be used to produce the ordered publication at or above a predetermined standard.

8. The system of claim 7, wherein the content distribution service is configured to ingest the content by characterizing the content and, if indicated by the characterization, converting the content to a format from which it can be used to produce the publication.

9. The system of claim 7, herein:
upon a determination that the content can be used to produce the publication at or above the predetermined standard, the order distribution service is operable to communicate a production instruction for the content and the content distribution service is configured to communicate the ingested content for use in producing the ordered publication according to the production instruction; and
upon a determination that the content cannot be used to produce the ordered publication at or above the predetermined standard, the order distribution service is configured to reject the order for the one of the plurality of publications.

10. The system of claim 9, wherein upon a determination that the content cannot be used to produce the ordered publication at or above the predetermined standard, the catalog service is configured to stop advertising that publication as being available for publication.

11. A computer readable medium having instructions stored thereon that when executed by a processor implement a method comprising:
obtaining metadata and content for each of a plurality of publications
advertising the availability of the plurality of publications for production without first confirming that content for any of the plurality of publications can be qualified; and
attempting to qualify content for an ordered one of the publications having been advertised; and
fulfilling the order with qualified content only if the attempt is successful.

12. The medium of claim 11, wherein the method comprises receiving the order for the one of the plurality of publications, and wherein attempting to qualify content comprises, in response to the order, ingesting the content for the ordered publication and determining if the ingested content can be used to produce the ordered publication at or above a predetermined standard.

13. The medium of claim 12, wherein ingesting comprises characterizing the content and, if indicated by the characterization, converting the content to a format from which it can be used to produce the publication.

14. The medium of claim 12, wherein fulfilling comprises:
upon a determination that the content can be used to produce the publication at or above the predetermined standard, communicating a production instruction for the content and communicating the ingested content for use in producing the ordered publication according to the production instruction; and
upon a determination that the content cannot be used to produce the ordered publication at or above the predetermined standard, communicating a rejection of the order for the one of the plurality of publications.

15. The medium of claim 14, wherein the method comprises, upon a determination that the content can be used to produce the ordered publication at or above the predetermined standard, identifying the publication as qualified and, in response to a subsequent order for the publication, communicating a subsequent production instruction for the publication without first requesting that the content distribution service ingest the content for the ordered publication.
